(19) United States
(12) Patent Application Publication
(10) Pub. No.: US 2025/0180821 A1
(43) Pub. Date: Jun. 5, 2025

(54) FIBER OPTIC ADAPTER CORE AND FIBER OPTIC ADAPTERS CAPABLE OF OPTICALLY MATING DIFFERENT HARDENED CONNECTOR INTERFACES

(71) Applicant: CORNING RESEARCH & DEVELOPMENT CORPORATION, Corning, NY (US)

(72) Inventor: Joel Christopher Rosson, Hickory, NC (US)

(21) Appl. No.: 18/947,542

(22) Filed: Nov. 14, 2024

Related U.S. Application Data
(60) Provisional application No. 63/604,496, filed on Nov. 30, 2023.

(51) Int. Cl. G02B 6/38

(52) U.S. Cl. CPC G02B 6/3825; G02B 6/3831; G02B 6/3877

(57) ABSTRACT

A fiber optic adapter core that may be used as a portion of different fiber optic adapters suitable for receiving and optically mating different types of external fiber optic connectors with an indoor connector (e.g., non-hardened fiber optic connector) such as an SC connector or the like are disclosed. An adapter housing of the fiber optic adapters comprises a first component and a second component that cooperate for forming the adapter core cavity that receives the fiber optic adapter core. The fiber optic adapter may also have resilient member(s) therein for biasing the fiber optic adapter core within the adapter housing if desired. The fiber optic adapter core and the first component of the adapter housing advantageously cooperate to form a first sub-assembly that may support and accept different second components for forming different fiber optic adapters that allow optical mating of different types of external fiber optic connectors.

### PRIORITY APPLICATION

This application claims the benefit of priority of U.S. Provisional Application No. 63/604,496, filed on Nov. 30, 2023, the content of which is relied upon and incorporated herein by reference in its entirety.

### FIELD

Fiber optic adapters and a fiber optic adapter core used within the fiber optic adapters are disclosed. More specifically, the fiber optic adapter core provides a simplified design that can be used with different adapter housings using a common sub-assembly that is configurable for optically mating different types of hardened fiber optic connectors with an indoor (e.g., non-hardened) connector.

### BACKGROUND

Optical fiber is increasingly being used for a variety of applications, including but not limited to broadband voice, video, and data transmission. As bandwidth demands for optical fiber networks have increased over the years next generation products have been developed for outside plant applications. One example of next generation products for outside plant applications are hardened fiber optic connectors used for optical mating at nodes of the optical network. One supporting device for optical mating of hardened fiber optic connectors at nodes are fiber optic adapters that mate the hardened fiber optic connector with an opposing indoor type of connector such as an SC connector that are received at opposing ends of the fiber optic adapter. The fiber optic adapters for outside plant applications may have the indoor connector disposed inside a closure or terminal for environmentally protecting the indoor connector while the hardened fiber optic connector is an external fiber optic connector that is connected from outside of the closure or terminal.

The next generation of hardened fiber optic connectors that have been developed use different structures for securing the fiber optic connectors in a suitable device compared with the previous generation of fiber optic connectors used in outside plant applications. By way of example, one next generation fiber optic connector design uses a push-to-secure configuration for optical mating while the earlier generation of fiber optic connector used a rotating coupling nut for securing and optically mating the fiber optic connector. The next generation fiber optic connector is smaller and easier to use compared with the previous generation of fiber optic connector having a rotating coupling nut. Nonetheless, the previous generation of fiber optic connector with the rotating coupling nut is still widely in-use due to legacy builds where homes and premises were passed with previously installed distribution cables, nodes and terminals that have fiber optic adapters configured for these earlier fiber optic connectors. Thus, to connect to this previous built infra-structure there is still a need for the early generation of products such as fiber optic adapters. Although the next generation of fiber optic connectors are quickly being adopted there is still a need for fiber optic adapters that support the early generation of fiber optic connectors along with fiber optic adapters that support the next generation of fiber optic connectors. Moreover, there are still other fiber optic connector designs used in outside plant applications as well that require complimentary products.

There exists a need for improved designs for fiber optic adapters that allow optical mating to these external fiber optic connectors that case and improve manufacturing while still providing a quick and easy optical connectivity for a variety of external fiber optic connector types that may be used in optical networks such as outside plant applications.

### SUMMARY

The disclosure is directed to a simplified fiber optic adapter core that may be used within an adapter core cavity of an adapter housing that is configurable for receiving and optically mating different types of external fiber optic connectors with an indoor connector (e.g., non-hardened fiber optic connector) such as an SC connector or the like.

A first aspect of the disclosure is directed to a fiber optic adapter configured for receiving and optical mating an external fiber optic connector with an indoor connector. The fiber optic adapter comprises a rear core and a front core that define a fiber optic adapter core when assembled. The rear core comprises a rear core body having a rear core passageway extending from a rear core rear end to a rear core front end and a flange disposed between the rear core rear end the rear core front end. The front core comprises a front core body having a front core passageway extending from a front core rear end to a front core front end, wherein the assembly of the front core with the rear core defines the fiber optic adapter core. One or more resilient members are configured for engaging the flange of the rear core and biasing the fiber optic adapter core and an adapter housing comprising a first component and a second component. The first component cooperates with the second component and defines an adapter core cavity for capturing the fiber optic adapter core and the one or more resilient members within the adapter core cavity when the fiber optic adapter is assembled, and the second component defines a second component passageway extending from a second component first end to a second component second end and the second component is configured for receiving a portion of the external fiber optic connector within the second component passageway for optical mating within the fiber optic adapter.

Another aspect of the disclosure is directed to a fiber optic adapter configured for receiving and optical mating an external fiber optic connector with an indoor connector. The fiber optic adapter comprises a rear core and a front core that define a fiber optic adapter core when assembled. The rear core comprises a rear core body having a rear core passageway extending from a rear core rear end to a rear core front end and a flange disposed between the rear core rear end the rear core front end. The front core comprises a front core body having a front core passageway extending from a front core rear end to a front core front end, wherein the assembly of the front core with the rear core defines the fiber optic adapter core. One or more resilient members are configured for engaging the flange of the rear core and biasing the fiber optic adapter core and an adapter housing comprising a first component and a second component that is a portion of a retaining sub-assembly. The first component cooperates with the second component of the retaining sub-assembly and defines an adapter core cavity for capturing the fiber optic adapter core and the one or more resilient members within the adapter core cavity when the fiber optic adapter is assembled. The second component defines a second component passageway extending from a second component first end to a second component second end and the second component is configured for receiving a portion of the external fiber optic connector within the second component passageway for optical mating within the fiber optic adapter.

Yet another aspect of the disclosure is directed to a fiber optic adapter configured for receiving and optical mating an external fiber optic connector with an indoor connector. The fiber optic adapter comprises a rear core and a front core that define a fiber optic adapter core when assembled. The rear core comprises a rear core body having a rear core passageway extending from a rear core rear end to a rear core front end and a flange disposed between the rear core rear end the rear core front end. The front core comprises a front core body having a front core passageway extending from a front core rear end to a front core front end, wherein the assembly of the front core with the rear core defines the fiber optic adapter core. One or more resilient members are configured for engaging the flange of the rear core and biasing the fiber optic adapter core along with an adapter housing comprising a first component and a retaining sub-assembly comprising a second component and a pivoting latch. The first component cooperates with the second component and defines an adapter core cavity for capturing the fiber optic adapter core and the one or more resilient members within the adapter core cavity when the fiber optic adapter is assembled. The second component defines a second component passageway extending from a second component first end to a second component second end and the second component is configured for receiving a portion of the external fiber optic connector within the second component passageway with the pivoting latch configured for rotating transversely to a longitudinal axis of the fiber optic adapter for releasing the external fiber optic connector from the fiber optic adapter.

Another aspect of the disclosure is directed to a fiber optic adapter core configured for use in a fiber optic adapter configured for receiving and mating an external fiber optic connector with an indoor connector. The fiber optic adapter core comprising a rear core and a front core. The rear core comprising a rear core body having a rear core passageway extending from a rear core rear end to a rear core front end and a flange disposed between the rear core rear end and the rear core front end along with a plurality of openings disposed through a wall of the rear core with the rear core is configured for receiving the indoor connector into the rear core passageway. The front core comprising a front core body having a front core passageway extending from a front core rear end to a front core front end and a plurality of latch arms extending from a medial portion of the front core and sized for passing through respective openings of the rear core. The plurality of latch arms being configured for securing the indoor connector within the rear core with the front core and the rear core defining the fiber optic adapter core when assembled.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the concepts and are incorporated into and constitute a part of this specification. The drawings illustrate various embodiments and together with the description serve to explain the principles and operation.

### BRIEF DESCRIPTION OF THE FIGURES

FIGS. 1 and 2 are perspective views of a first assembled fiber optic adapter configured for receiving and optically mating an external fiber optic connector with an indoor connector according to the concepts disclosed;

FIG. 3 is a partially exploded view of the fiber optic adapter of FIGS. 1 and 2 that comprises an adapter housing having a first component and a second component that define an adapter core cavity configured for capturing a fiber optic adapter core;

FIG. 4 is an exploded view of the fiber optic adapter of FIGS. 1 and 2;

FIG. 5 is an exploded view of the fiber optic adapter core used in the fiber optic adapters of FIGS. 1-4 and FIGS. 34 and 35;

FIGS. 6 and 7 are perspective views of the rear core of the fiber optic adapter core of FIG. 5;

FIG. 8 is a perspective view of the front core of the fiber optic adapter core of FIG. 5;

FIGS. 9 and 10 are longitudinal sectional views of the assembled fiber optic adapter core of FIG. 5;

FIG. 11 depicts a rear perspective view of the fiber optic adapter core having the resilient member disposed about a rear end of the rear core in preparation for insertion into the first component of the adapter housing;

FIG. 12 shows a rear perspective view of the fiber optic adapter core and resilient member placed within the first component of the adapter housing to form a first sub-assembly;

FIG. 13 depicts a sectional view of the first sub-assembly of FIG. 12 that is suitable for receiving different second components for forming the fiber optic adapters suitable for optically mating different types of external fiber optic connectors;

FIG. 14 is an exploded view of a retaining sub-assembly comprising a second component that may cooperate with the first sub-assembly of FIGS. 12 and 13 for forming the fiber optic adapter of FIGS. 1-4;

FIG. 15 is an assembled sectional view of the retaining sub-assembly of FIG. 14 showing details of the construction;

FIGS. 16-18 are sectional views of the retaining sub-assembly of FIGS. 14 and 15 securing and releasing an external fiber optic connector that may be received at the second component second end;

FIGS. 19 and 20 are perspective views of the second component of the retaining sub-assembly of FIGS. 14-18 used with the fiber optic adapter of FIGS. 1-4;

FIGS. 21 and 22 are perspective views of the pivoting latch of the retaining sub-assembly of FIGS. 14-18 used with the fiber optic adapter of FIGS. 1-4;

FIGS. 23 and 24 are perspective views of the slider of the retaining sub-assembly of FIGS. 14-18 used with the fiber optic adapter of FIGS. 1-4;

FIGS. 25 and 26 are perspective views of the inner body of the retaining sub-assembly of FIGS. 14-18 used with the fiber optic adapter of FIGS. 1-4;

FIGS. 27-31 are perspective views showing the assembly of the retaining sub-assembly of FIGS. 14-18 used with the fiber optic adapter of FIGS. 1-4;

FIGS. 32 and 33 are perspective views showing the assembled retaining sub-assembly of FIGS. 14-18 with the slider removed for the sake of clarity to show further details of the assembled components;

FIGS. 34 and 35 are perspective views of a second assembled fiber optic adapter using a first sub-assembly having the fiber optic adapter core and first component that is configured for receiving and optically mating an external fiber optic connector having a threaded coupling nut with an indoor connector according to the concepts disclosed herein;

FIG. 36 shows a front perspective view showing the first sub-assembly having with the fiber optic adapter core and resilient member placed within the first component to form the first sub-assembly;

FIG. 37 shows a rear perspective view of the second component used in the fiber optic adapter of FIGS. 34 and 35 that is configured for receiving and optically mating an external fiber optic connector having a threaded coupling nut; and

FIGS. 38 and 39 are longitudinal sectional views taken along the connector insertion axis showing details of the fiber optic adapter of FIGS. 34 and 35.

### DETAILED DESCRIPTION

Reference will now be made in detail to the embodiments of the disclosure, examples of which are illustrated in the accompanying drawings. Whenever possible, like reference numbers will be used to refer to like components or parts.

The concepts disclosed herein are directed to a simplified fiber optic adapter core that may be used within an adapter core cavity of an adapter housing being configurable for receiving and optically mating different types of external fiber optic connectors with an indoor connector (e.g., non-hardened fiber optic connector) such as an SC connector or the like. Generally speaking, the fiber optic adapter is configured for being mounted to a wall of an enclosure or the like so that the side of the fiber optic adapter receiving the indoor connector is protected within the enclosure, and the opposing side of the fiber optic adapter receiving the external fiber optic connector is presented to the environment outside of the enclosure.

The concepts disclosed advantageously disclose an adapter housing comprising a first component and a second component that cooperate to form the adapter core cavity that receives the fiber optic adapter core. The adapter core cavity may also receive one or more resilient members therein for biasing the fiber optic adapter core within the adapter housing if desired. The fiber optic adapter core and the first component of the adapter housing advantageously cooperate to form a first sub-assembly that may support and accept different second components for forming different fiber optic adapters that allow optical mating of different types of external fiber optic connectors. Consequently, the first sub-assembly for the fiber optic adapters allows the flexibility for supporting the optical mating of different types of external fiber optic connectors by changing out the second component, thereby allowing the optical mating of the desired external fiber optic connector. Further, the second component may be a single component or a portion of a retaining sub-assembly that cooperates with the first sub-assembly for forming the fiber optic adapter.

Further, the fiber optic adapters according to the concepts disclosed may further support still other types of external fiber optic connectors by using different second components for the adapter housing of the fiber optic adapters along with the first sub-assembly if desired, thereby providing further flexibility for supporting other types of external fiber optic connectors as desired. By way of explanation, the second component of a fiber optic adapter may be a portion of retaining sub-assembly having a pivoting latch configured for securing a first type of external fiber optic connector that excludes a threaded coupling nut such as the Pushlok® connector available from Corning Optical Communications of Charlotte, NC. Alternatively, the second component of a fiber optic adapter may have an internal threaded portion configured for securing a second type of external fiber optic connector that includes a threaded coupling nut such as the OptiTap® connector available from Corning Optical Communications of Charlotte, NC. Still other second components are possible for a different type of external fiber optic connector if desired such as connectors having bayonets or other mating structures.

Thus, the concepts disclosed provide an improved and simplified fiber optic adapter core along an adapter housing that allow flexibility and configurability for supporting the optical mating of different types of external fiber optic connectors with a suitable indoor fiber optic connector. The concepts disclosed herein are suitable for outside plant applications such as fiber-to-the-home, fiber-to-the-curb or 5G and are equally applicable to other optical applications such as indoor, industrial, or other suitable applications. The concepts will be described in more detail herein.

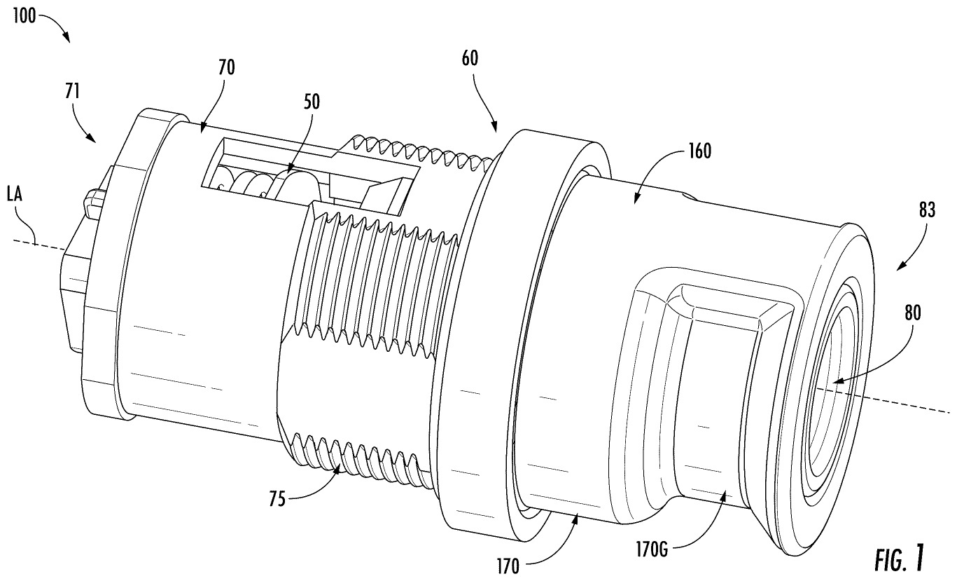

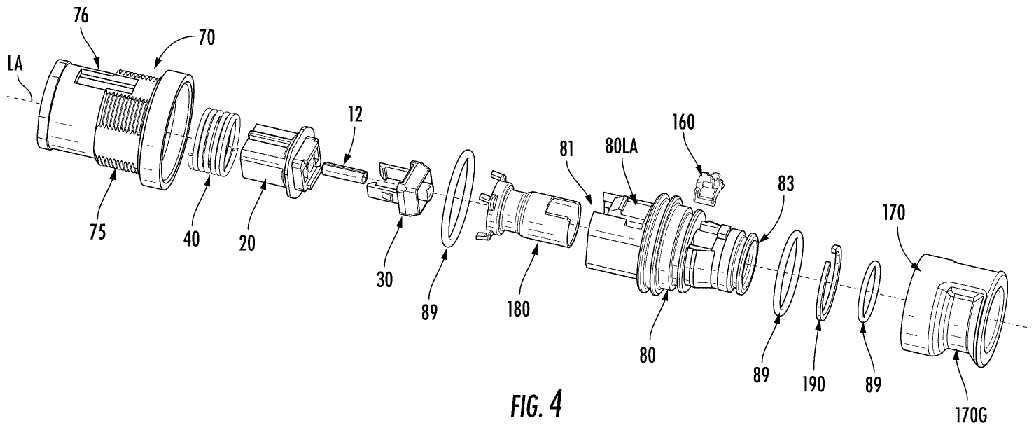

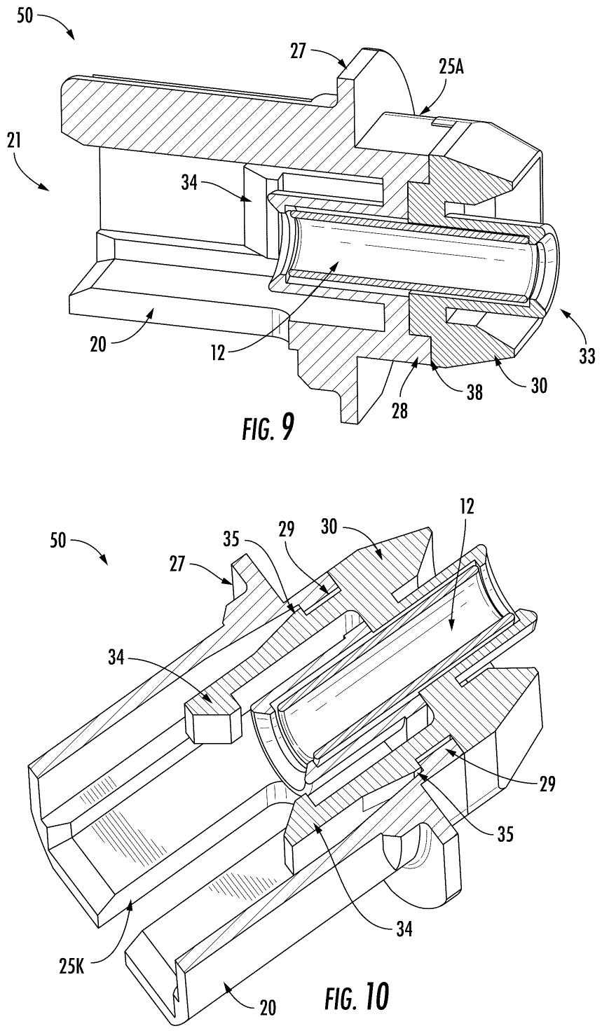

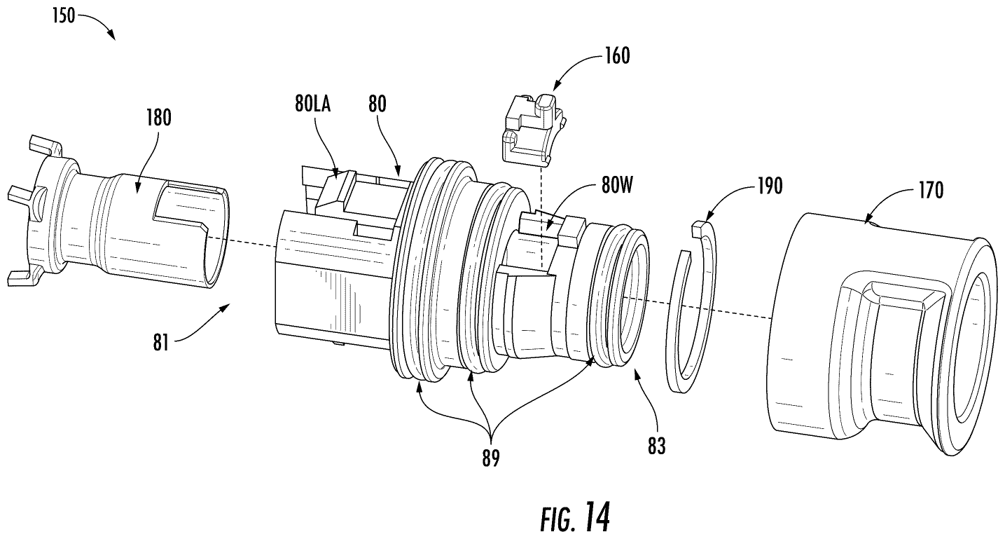

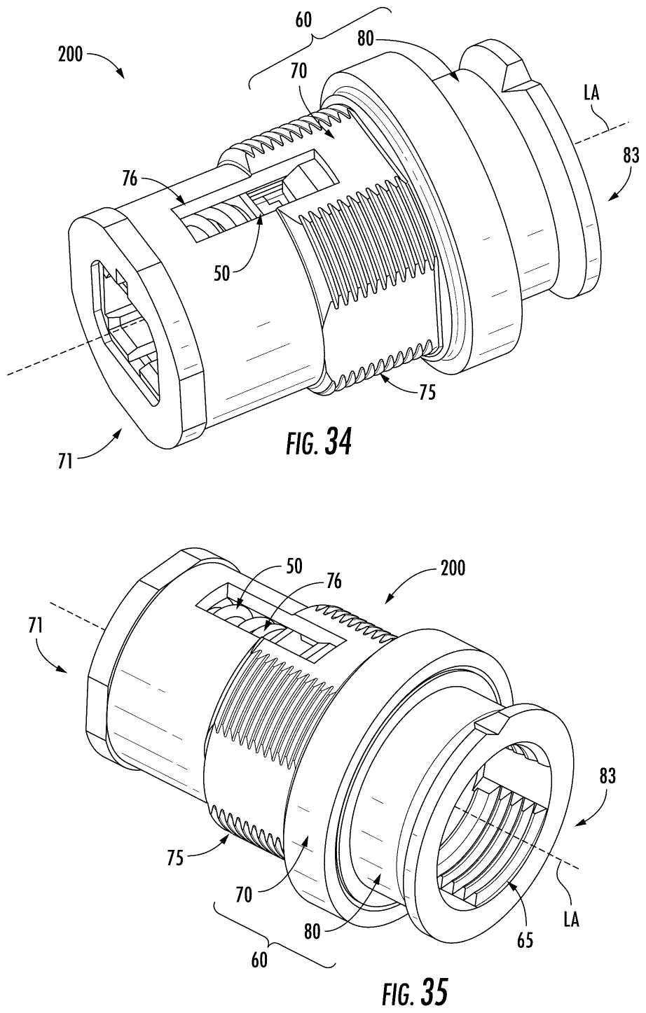

FIGS. 1-4 depict views of a first fiber optic adapter 100 configured for receiving and optically mating an external fiber optic connector such as a Pushlok connector with an indoor connector. FIGS. 5-10 depict view of a fiber optic adapter core 50 and its components that may be used with the different types of fiber optic adapters 100,200 disclosed herein. FIGS. 11-13 show the assembly and construction of the first sub-assembly that is useful for supporting different second components configured for different types of external fiber optic connectors. FIGS. 14-33 show the assembly, components and construction of a retaining sub-assembly 160 comprising second component 80 shown in fiber optic adapter 100 of FIGS. 1-4. FIGS. 34-37 depict views of a second fiber optic adapter 200 configured for receiving and optically mating an external fiber optic connector such as an OptiTap connector with an indoor connector.

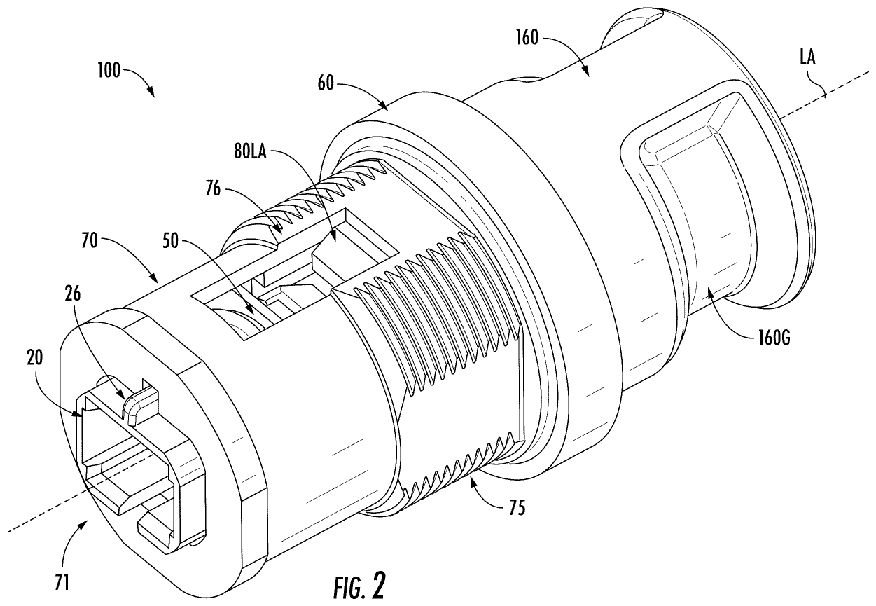

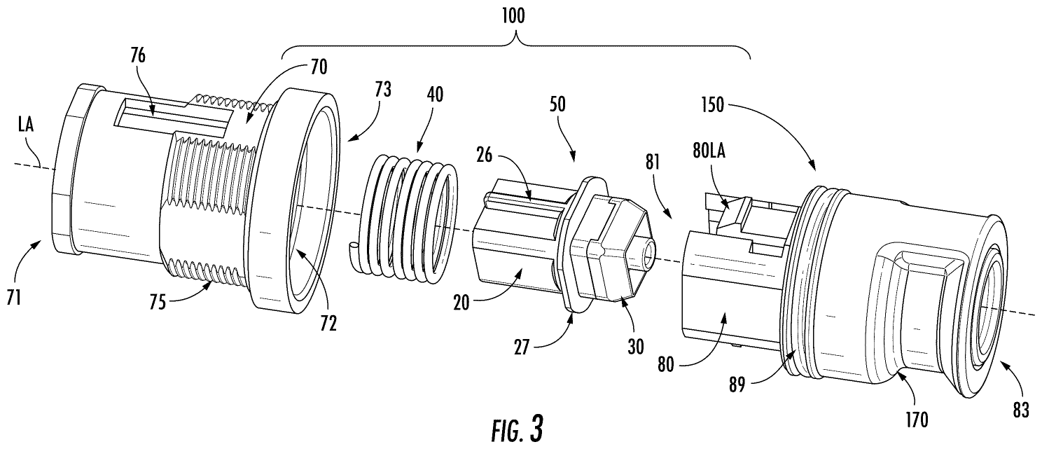

FIGS. 1 and 2 are perspective views of the first assembled fiber optic adapter 100 configured for receiving and optically mating an external fiber optic connector with a Pushlok connector with an indoor connector such as an SC connector that are received at opposing ends of the fiber optic adapter 100. Specifically, the SC connector may be received at a first component first end 71 of the first component 70 and into the respective portion of the fiber optic adapter core 50. Likewise, the Pushlok connector may be received at a second component second end 83 of the second component 80 for optical mating with the SC connector inserted at the opposing end. FIGS. 3 and 4 are exploded views of the fiber optic adapter 100 of FIGS. 1 and 2 showing the various components and construction.

As shown, an adapter housing 60 comprises a first component 70 and a second component 80 that cooperate to define an adapter core cavity 62. The adapter core cavity 62 is configured for capturing the fiber optic adapter core 50 and one or more resilient members 40 within the adapter core cavity 62 when the fiber optic adapter 100 is assembled. The first component 70 comprises a first component passageway 72 extending from a first component first end 71 to a first component second end 73. First component passageway 72 forms a portion of the adapter core cavity 62. Likewise, the second component 80 comprises a second component passageway 82 extending from a second component first end 81 to a second component second end 83. The second component passageway 82 forms a portion of the adapter core cavity 62 when the fiber optic connector 100 is assembled.

Second component 80 may comprise one or more latch arms 80LA configured as a cantilevered arm for securing the second component 80 with the first component 70 of the adapter housing 60. During assembly, the one or more latch arms 80LA may be aligned with appropriate structure on the first component 70 such as first component windows 76 so that the latch arms deflect and then spring back so the ends of the latch arms 80LA are captured within the first component windows 76 as shown in FIG. 2. The first component windows 76 may also be oversized in the direction of the longitudinal axis LA as desired for providing an inspection window for proper assembly. If desired, the second component 80 and first component may be keyed so that they only assemble in one orientation. As best shown in FIG. 3, an O-ring 89 or the like may be disposed within an appropriately sized groove (not numbered) and sized for providing an environmental seal between the first component 70 and the second component 80 when assembled. The first component 70 may comprise an external threaded portion 75 disposed rearward of a shoulder (not numbered) adjacent to the first component second end 73. The external threaded portion 75 is configured for receiving a retaining nut (not shown) for mounting the fiber optic adapter 100 to a wall of an enclosure or the like as desired. An O-ring or gasket (not shown) may also be disposed between the shoulder of the first component 70 and the retaining nut (not shown) for providing environmental protection during mounting of the fiber optic adapter if desired.

FIG. 4 depicts a fully exploded view of the fiber optic adapter 100 for showing the components of the fiber optic adapter core 50 and the second component 80 comprising a portion of the retaining sub-assembly 150 as explained in further detail herein.

FIG. 5 is an exploded view of the fiber optic adapter core 50 used in the fiber optic adapter 100 of FIGS. 1-4 and fiber optic adapter 200 of FIGS. 34 and 35. As shown, fiber optic adapter core 50 comprises a rear core 20 and a front core 30 that define the fiber optic adapter core 50 when assembled. Fiber optic adapter core 50 may optionally include a ferrule split sleeve 12 captured between the rear core 20 and the front core 30 for precision alignment of the opposing mating ferrules of the indoor connector and the external fiber optic connector if desired. However, the precision geometry for the alignment of the mating ferrules could be incorporated into the rear core 20 and front core 30 if desired. Fiber optic adapter core is a simplified design and uses fewer parts than other devices and can avoid the tolerance stack-up of design with a greater number of components.

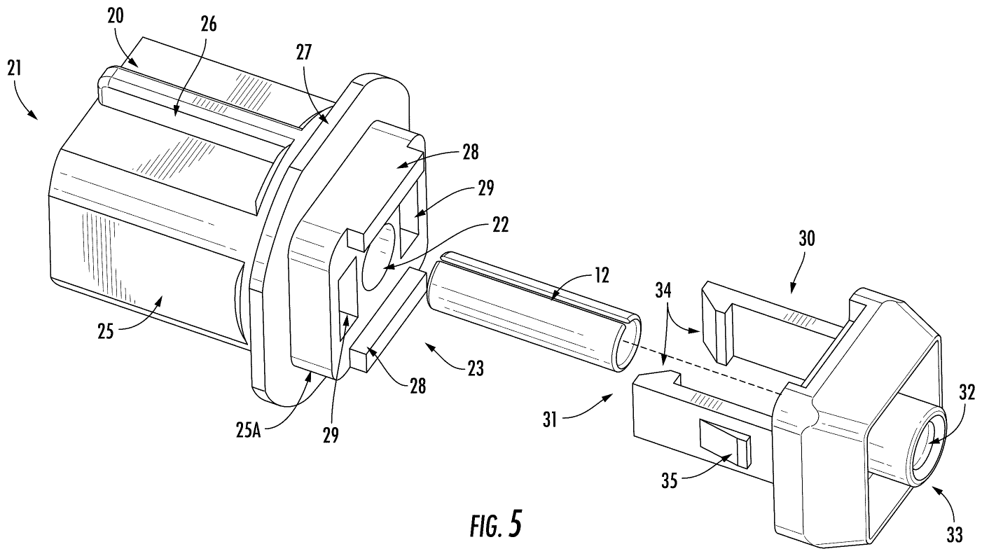

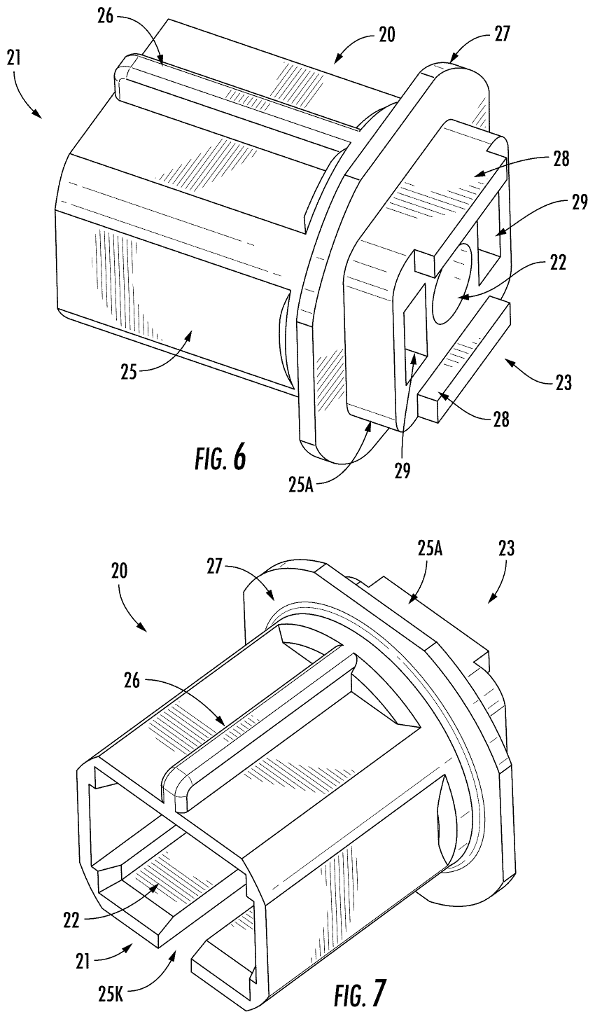

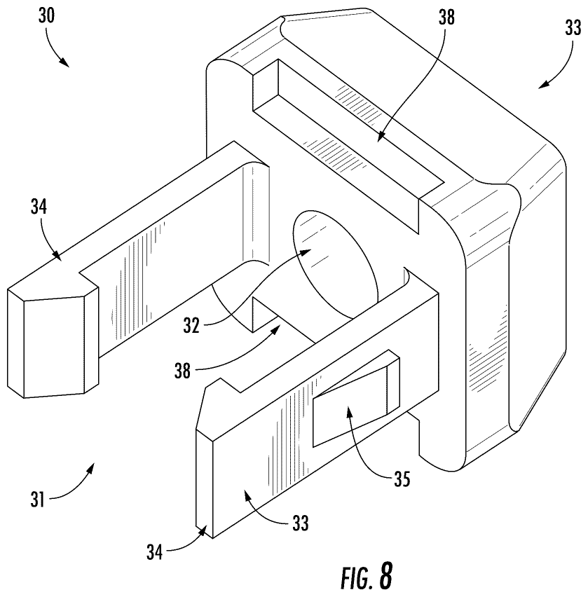

FIGS. 6 and 7 are perspective views of the rear core 20 of the fiber optic adapter core 50 and FIG. 8 is a perspective view of the front core 30 of the fiber optic adapter core 50. FIGS. 9 and 10 are longitudinal sectional views taken along the longitudinal axis LA of the assembled fiber optic adapter core 50 for showing further details.

Rear core 20 comprises a rear core body 25 having a rear core passageway 22 extending from a rear core rear end 21 to a rear core front end 23. Likewise, the front core 30 comprises a front core body 35 having a front core passageway extending from a front core rear end 31 to a front core front end 33. As best shown in FIGS. 9 and 10, a portion of the rear core passageway 22 is sized for receiving a portion of the split ferrule sleeve 12, and a portion of the front core passageway 32 is sized for receiving a portion of the split sleeve ferrule 12. More specifically, the rear core passageway 22 and the front core passageway 32 cooperate to capture the split ferrule sleeve 12 in a loosely captive manner for allowing slight movement of the split ferrule sleeve 12 when the fiber optic adapter core 50 is assembled.

The rear core 20 also comprises a portion 25A of the rear core 20 that has features for cooperating with the front core 30. Specifically, the rear core 20 comprises alignment features 28 such as a plurality of protrusions 28 that cooperate with the alignment features 38 such as recesses on the front core 30. Of course, other structures are possible for aligning the rear core 20 with the front core 30. For instance, the rear core 20 could have the recesses and the front core 30 could have the protrusions if desired or pin and bores could be used, etc. If desired, the respective alignment features 28,38 could be selected so that the rear core 20 and the front core only properly assembled in one orientation such as having different widths for the protrusions and recesses or other variations for providing assembly in only one orientation.

The rear core 20 also comprises a plurality of openings 29 disposed through a wall of the rear core 20 as best shown in FIGS. 6 and 10. Front core 30 comprises a plurality of latch arms 34 extending from the medial portion of the front core (30). The openings 29 of the rear core 20 are sized for receiving the latch arms 34 of the front core therethrough for assembly. The latch arms 34 also include locking features 35 disposed on the outboard sides for engaging with the wall of the rear core 20 such as shown in FIG. 10. The locking features 35 act as a primary retention between the rear core 20 and the front core 30 of the fiber optic adapter corc 50 when assembled. For instance, the locking features 35 can provide a snap-fit assembly between the rear core 20 and the front core 30. Once assembled, the latch arms 34 extend into the rear core passageway 22 for engaging and securing the indoor connector therein once fully-inserted.

The rear portion of the rear core passageway 22 of the rear core 20 is sized and shape for receiving the desired indoor connector such as an SC connector as known in the art into the rear core passageway at the rear core rear end 21 as best shown in FIG. 7. A keying slot 25K or the like may be disposed at the rear core rear end 21 for keying the desired rotational orientation for the indoor connector received for optical mating at the rear core rear end 21. When the indoor connector is fully inserted into the fiber optic adapter core 50 the ferrule of the indoor connector can enter the ferrule split sleeve 12 held by the fiber optic adapter core 50 from the rear core side. Further, a secondary retention between the rear core 20 and front core 30 is provided once the indoor connector is fully-inserted into the fiber optic adapter core 50 since the indoor connector will flex the latch arms 34 outward and will further secure the rear core 20 and the front core 30 of the fiber optic adapter core 50 due to the outward flexing of the latch arms 34 provided by indoor connector. Likewise, when the external fiber optic connector is fully inserted into the fiber optic adapter 100,200 the ferrule of the external fiber optic connector can enter the ferrule split sleeve 12 held by the fiber optic adapter core 50 from the front core side for optical mating of the opposing ferrules.

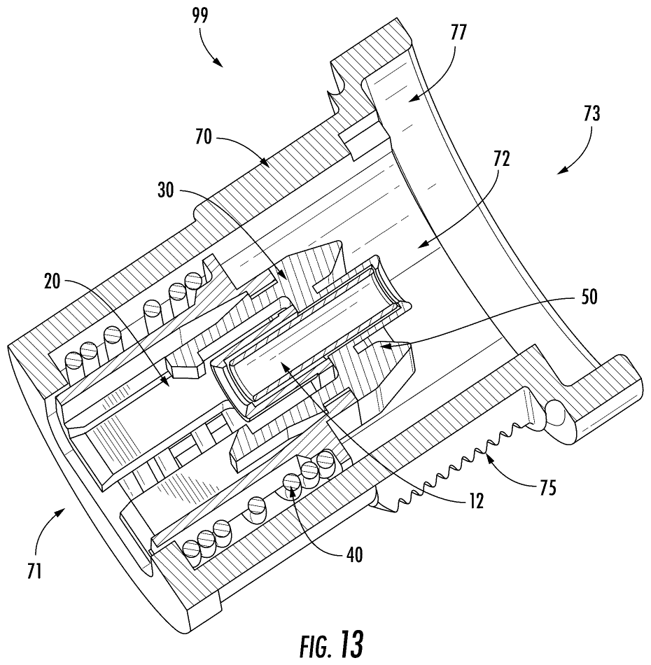

A flange 27 may be disposed between the rear core rear end 21 and the rear core front end 23. The flange 27 can provided a push surface for the one or more resilient members 40 to abut and bias the fiber optic adapter core 50 within the adapter housing 60 when assembled as shown in FIGS. 11 and 13. Adjacent the flange 27 can be one or more surfaces shaped a spring seat for the desired resilient member. Other embodiments using the disclosed concepts could use a pair of resilient members 40 and the spring seats for the components would be sized and shaped accordingly for the desired resilient members. FIG. 11 shows a rear perspective view of the fiber optic adapter core 50 with the resilient member 40 comprising a diameter D configured for fitting about a rear end of the rear core 20 in preparation for insertion into the first component 70 of the adapter housing 60.

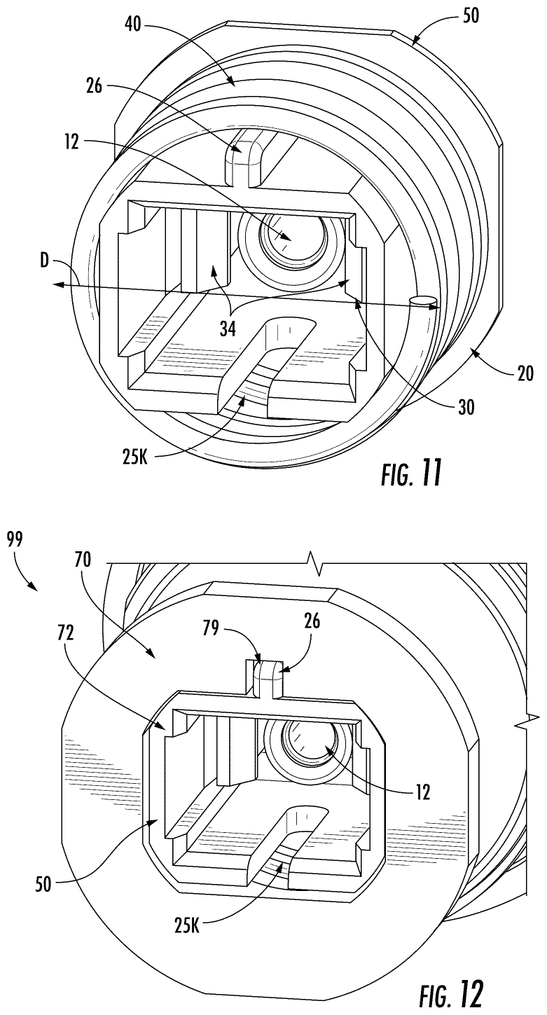

FIG. 12 shows a rear perspective view of the fiber optic adapter core 50 and resilient member 40 placed within the first component 70 of the adapter housing 60 to form a first sub-assembly 99. The rear core 20 may include a keying feature 26. If used, the keying feature 26 cooperates with a complimentary adapter keying feature 79 disposed on the first component 70 of the adapter housing as best shown in FIG. 12. When assembled, the one or more resilient members 40 are captured between the first component 70 and the flange 27 of the fiber optic adapter core 50 as shown in the sectional view of FIG. 13. The use of the one or more resilient members allows for movement of the fiber optic adapter core 50 within the adapter housing 60 to accommodate and excess forces during insertion of the connector(s) or optical mating.

FIG. 13 shows the assembly and construction of the first sub-assembly 99 used with different second components 80, which are configured for receiving different types of external fiber optic connectors for optical mating as discussed herein. First sub-assembly 99 comprises the fiber optic adapter core 50 and the first component 70 of the adapter housing 60 along with one or more resilient members 40 if used. Thus, the first sub-assembly 99 is advantageous for the ability to change out the second component 80 or sub-assembly having the second component and changing the type of external fiber optic connector that may be optically mated. As depicted, the first component 70 of the adapter housing 60 comprises an internal rim 77 configured for receiving and sealing between the first component 70 and the second component 80 using an O-ring 89 disposed within a groove 80G of the second component 80 such as depicted in FIG. 3.

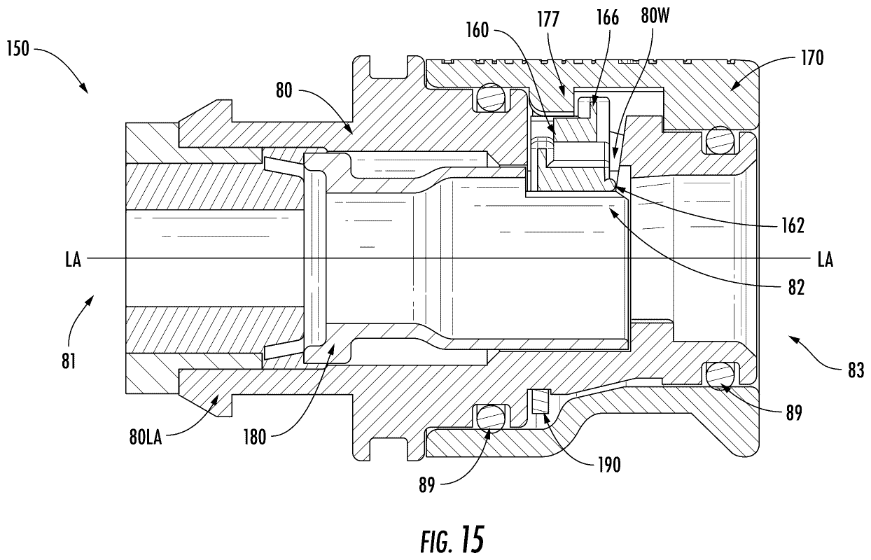

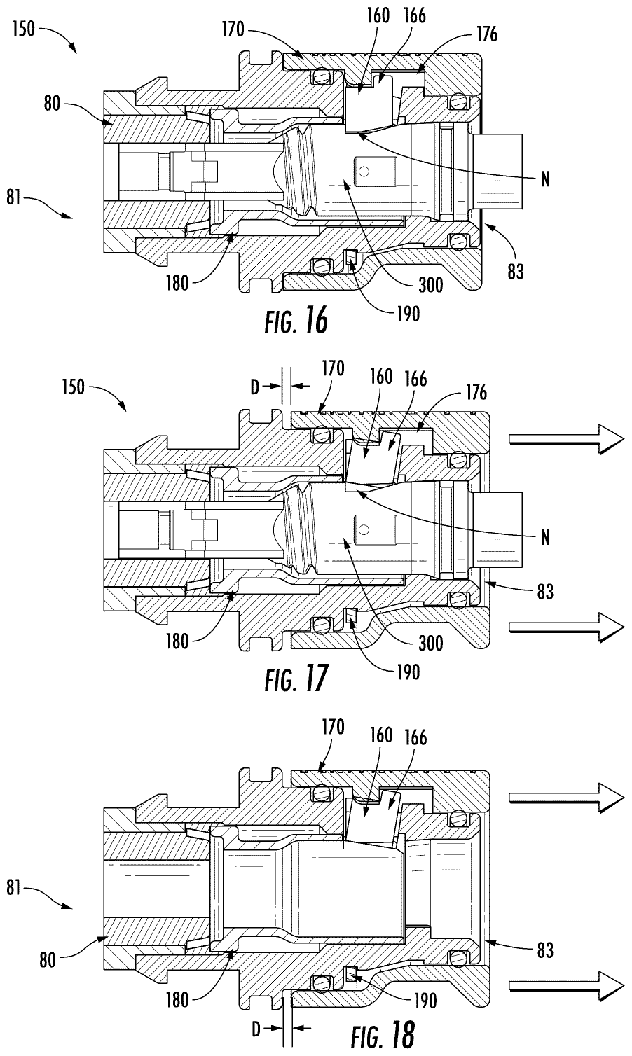

FIG. 14 is an exploded view of a retaining sub-assembly 150 comprising the second component 80 that may cooperate with the first sub-assembly 99 of FIGS. 12 and 13 for forming the fiber optic adapter 100 shown in FIGS. 1-4. FIG. 15 is an assembled sectional view along the longitudinal axis LA of the retaining sub-assembly 150 showing details of the construction. FIGS. 16-18 are sectional views of the retaining sub-assembly 150 securing and releasing an external fiber optic connector that may be received at the second end such as a Pushlok connector available from Corning Optical Communications of Charlotte, North Carolina. Retaining sub-assembly 150 receives a portion of the external fiber optic connector and retains or releases the same as discussed herein.

Returning to FIG. 14, retaining sub-assembly 150 comprises second component 80, a pivoting latch 160, a slider 170, an inner body 180 and a clip 190. As discussed above, the second component 80 secures the retaining sub-assembly 150 to the first component 70 of the first sub-assembly using latch arms 80LA that fit into respective first component windows 76 of the first component 70 for assembly. Second component comprises second component passageway 82 extending between the second component first end 81 and the second component second end 83 and receives a portion of the external fiber optic connector for optical mating. Second component 80 also comprises a second component window 80W configured for cooperating with the pivoting latch 160. Clip 190 and slider 170 cooperate with the pivoting latch 160 for retaining and releasing the external fiber optic connector as discussed in further detail herein. Inner body 180 is sized for fitting into the second component passageway 82 of the second component and retaining the assembly of components. The retaining sub-assembly 150 may also comprise one or more O-rings 89 for sealing between the second component 80 and the slider 170 if desired.

FIG. 15 shows the retaining sub-assembly 150 with the slider 170 and pivoting latch 160 in the retain position. In the retain position, a portion of the pivoting latch 160 interrupts the second component passageway 82 of the second component. The clip 190 provides a spring force for keeping the pivoting latch 160 in a normally-retain position for the retaining sub-assembly 160. Consequently, the suitable external fiber optic connector would be secured within the second component passageway 82 of the second component 80 in the normally-retain position such as shown in FIG. 16.

The pivoting latch 160 is configured for rotating transversely relative to the longitudinal axis LA of the fiber optic adapter 100 (and the retaining sub-assembly 150) for releasing the external fiber optic connector from the fiber optic adapter 100. The slider 170 is capable of moving along the longitudinal axis LA of the fiber optic adapter 100 in an outward direction for rotating the pivoting latch 160 to a release position.

When the suitable external fiber optic connector is properly aligned and inserted into the retaining sub-assembly 150, the external fiber optic connector will engage the pivoting latch 160 as it is inserted and rotate the pivoting latch 160 to the release position during connector insertion until the suitable external fiber optic connector is fully-inserted and then the spring force of the clip 190 will bias the pivoting latch 160 to the retain position for securing the external fiber optic connector within the retaining sub-assembly 150 using the pivoting latch 160. Consequently, the fiber optic adapter 100 using the retaining sub-assembly 150 can quickly and easily optical mate the external fiber optic connector without using a coupling nut like other types of connectors.

Further details of the of retaining sub-assembly 150 are discussed herein. Any suitable geometry or construction may be used on the slider 170 for rotating the pivoting latch 160 to the release position. By way of explanation, the slider 170 comprises a slider pull catch 177 that engages the pull 166 disposed on the top side of the pivoting latch 160 as the slider 170 moves to right as depicted by the large arrows in FIGS. 17 and 18.

As the slider 170 moves to the right as represented by the large arrows the pull catch 177 engages the pivoting latch 160 and provides a force on the pull 166 of the pivoting latch 160 for creating rotation of the pivoting latch 160 transversely relative to the longitudinal axis LA of the fiber optic adapter (and the retaining sub-assembly 150) about pivots 162 disposed on the bottom side of the pivoting latch 160.

FIGS. 16 and 17 depicts the operation of the retaining sub-assembly 160 for retaining and releasing with the external fiber optic connector (not numbered) disposed within the second component passageway 82. FIG. 18 shows the retaining sub-assembly 160 in the release position without the external fiber optic connector.

FIG. 16 depicts the external fiber optic connector within the retain sub-assembly 150 and the pivoting latch 160 in the retain position and engaging a notch N of the external fiber optic connector (i.e., the normally-retain position with the external fiber optic connector in the retain sub-assembly 150). As shown in FIG. 17, pulling the slider 170 to the right a distance D as represented by the large arrows causes the pivoting latch 160 to rotate about the pivots 162 in the second component window 80W of the second component 80. As the pivoting latch 160 rotates about the pivots 162, the rear end 161 of the pivoting latch 160 moves upward away from the longitudinal axis and the spreading protrusions 164 disposed on the upper portion of the rear end 161 cause the arms of clip 190 spread further apart against the restoring spring force of the clip 190. Once the slider 170 moves a sufficient distance D to the right as shown in FIG. 17, the pivoting latch 160 is in the release position and clears the notch N of the external fiber optic connector disposed in the retain sub-assembly 150, thereby allowing the external fiber optic connector to be removed from the retain sub-assembly 150. FIG. 18 shows the pivoting latch 160 in the release position with the external fiber optic connector removed from the retain sub-assembly 150.

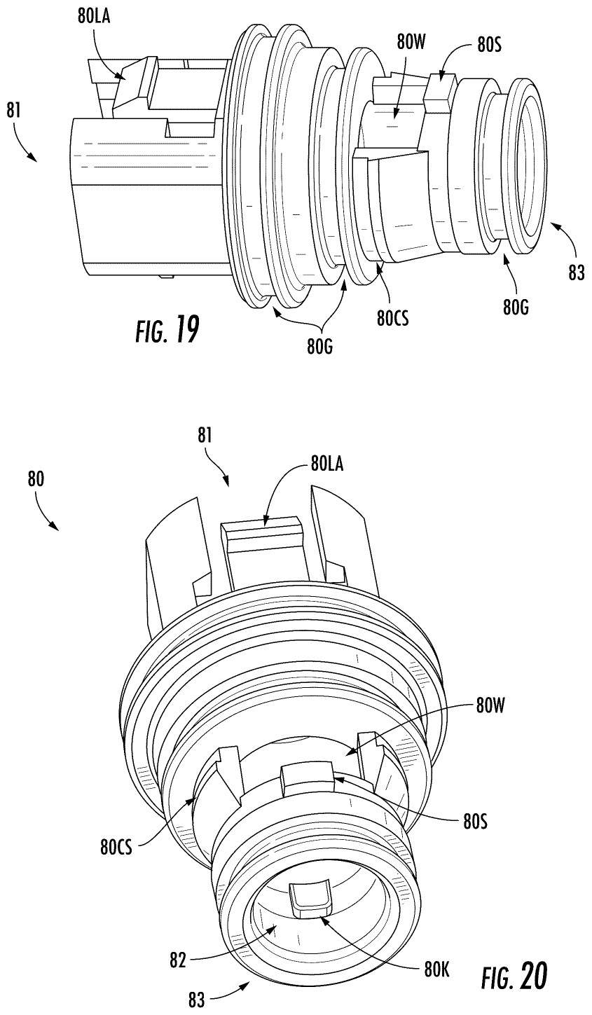

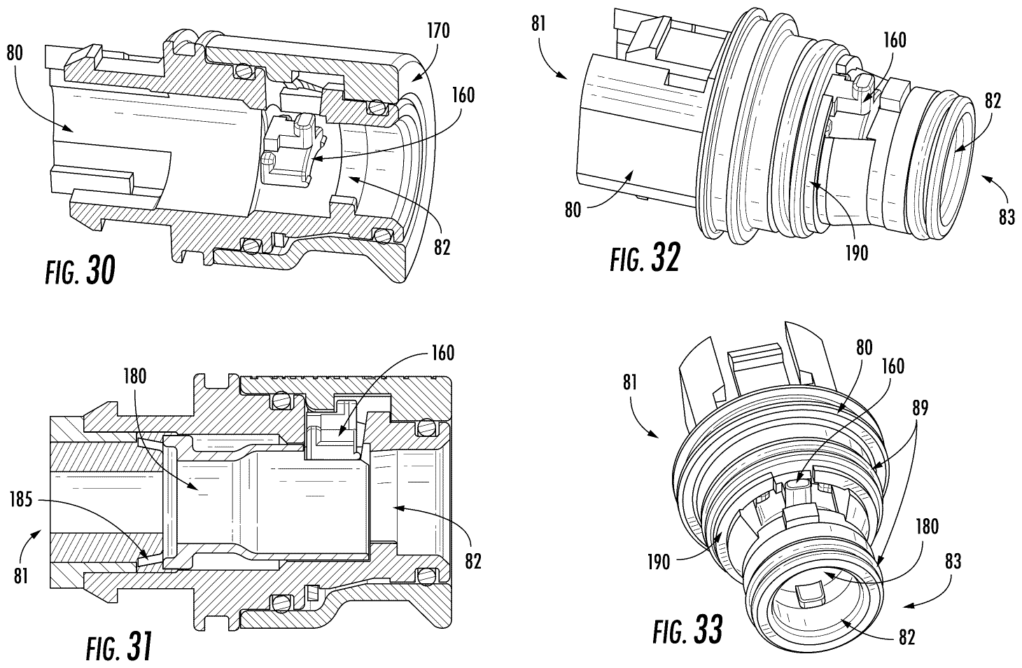

FIGS. 19 and 20 are perspective views showing details of the second component 80 of the retaining sub-assembly 160. Second component 80 comprises second component passageway 82 extending from the second component first end 81 to the second component second end 83. As best depicted in FIG. 20, the second component window 80W is rotationally disposed about 180 degrees from a keying portion 80K disposed within the second component passageway 82. Second component 80 also comprises a clip seat 80CS that is generally aligned with the second component window. The clip 190 is configured as a C-shaped clip and sized for fitting to the clip seat 80CS for providing a restoring force to the pivoting latch 160. Specifically, the clip seat 80CS is generally aligned with the spreading protrusion 164 of the pivoting latch when assembled in the retaining sub-assembly 160. More specifically, end portions of the clip 190 are positioned over the spreading protrusions 164 of the pivoting latch 160 when assembled as best shown in FIGS. 32 and 33.

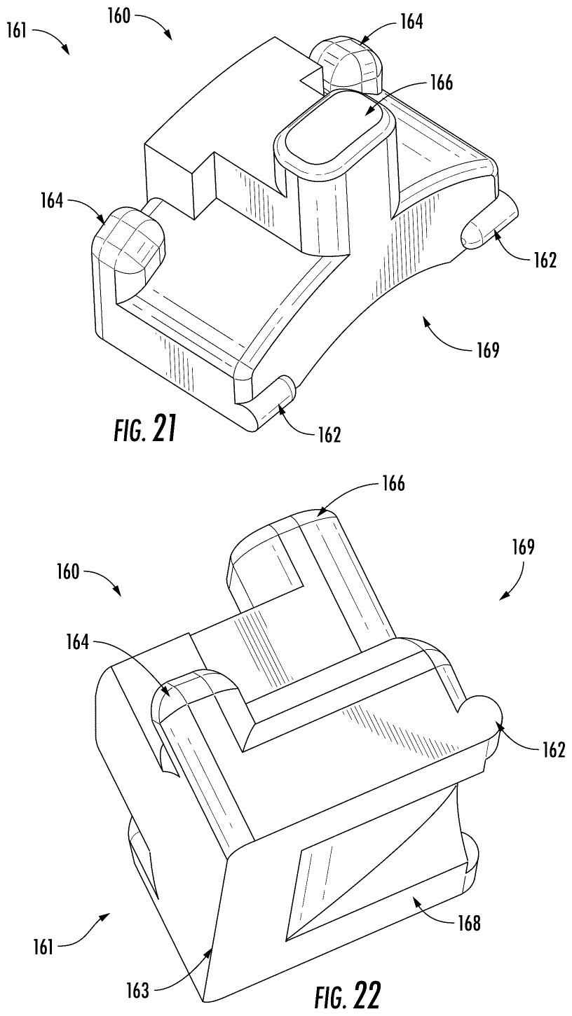

FIGS. 21 and 22 are perspective views showing details of the explanatory pivoting latch 160 of the retaining sub-assembly 160. Other structures or arrangements may be used with the disclosed concepts for the pivoting latch and retaining sub-assembly shown is merely explanatory for the concepts.

As shown, the pivoting latch 160 comprises pivots 162 at the lower portion opposite of the spreading protrusions 164. The pivots 162 may have any suitable shape or size for engaging and cooperating with a portion of the second component 80 near the second component window 80W for creating a suitable fulcrum for the rotation of the pivoting latch 160. As depicted, the pivots 162 are spaced apart on a forward end 169 of pivoting latch 160. Further, the pivots 162 are disposed near a lower portion of the pivoting latch 160 for engaging with the second components. The spreading protrusions 164 may be disposed on the upper portion of the rear end 161 are generally positioned to align with the clip 190 when assembled. Pivoting latch 160 also comprises a pull 166 that cooperates with the slider 170. The pull 166 is disposed on the upper portion of the pivoting latch 160 for cooperating with the slider 170 on an inner surface.

Pivoting latch 160 may also include a retention surface 163 at the lower portion of the front end 161 for cooperating with the retention feature (i.e., the notch) disposed on the suitable external fiber optic connector such as shown in FIG. 16. A lower surface 168 of the pivoting latch 160 facing the second component passageway 82 of the second component 80 has a suitable geometry for engaging the external fiber optic connector for moving the pivoting latch from the normally-retain position to the release position for insertion and retention. Specifically, the external fiber optic connector will engage the lower surface 168 of the pivoting latch 160 as it is inserted and rotate the pivoting latch 160 at the pivots 162 for moving to the release position during connector insertion until the suitable external fiber optic connector is fully-inserted and then the spring force of the clip 190 will bias the pivoting latch 160 back to the normally-retain position for securing the external fiber optic connector within the retaining sub-assembly 150 with the pivoting latch 160 engaging the notch N on the connector housing as depicted in FIG. 16.

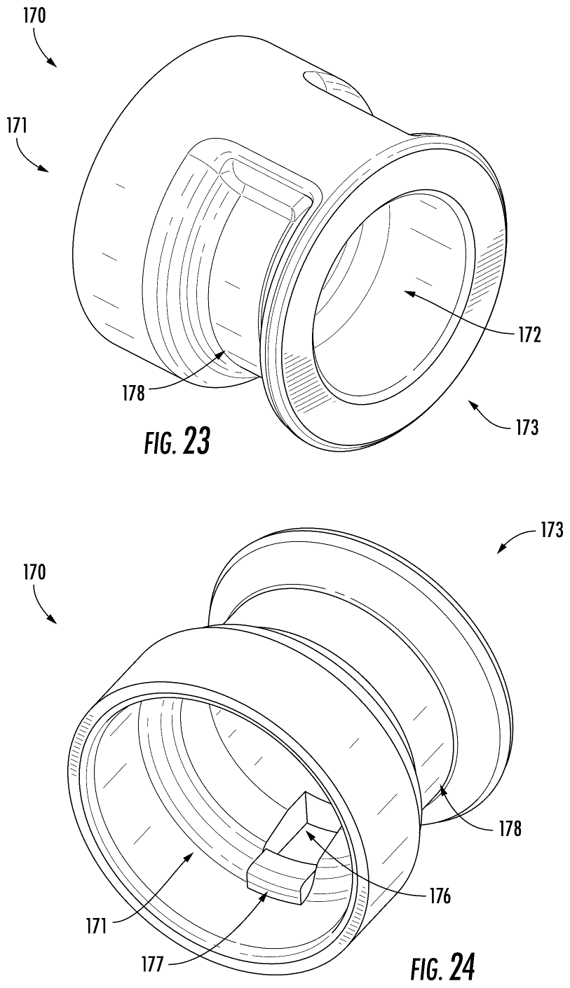

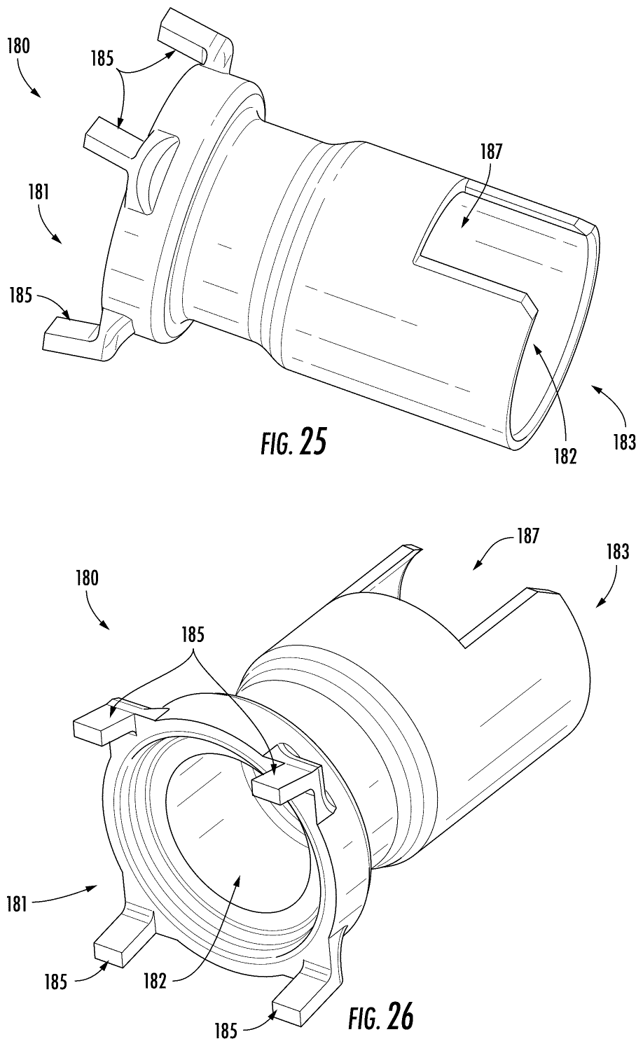

FIGS. 23 and 24 are perspective views showing details of the slider 170 of the retaining sub-assembly 160. Slider 170 comprises a slider passageway 172 extending between a slider rear end 171 to a slider front end 173. A guide 175 may be disposed on the inner wall of the slider 170 within the slider passageway 172 as shown in FIG. 24. The guide 175 keeps the slider aligned to cooperate with the pull 166 on the pivoting latch and inhibiting the slider 170 from excess rotation that could cause misalignment. The guide 175 is configured as a channel and the pull 166 fits into the guide 175 as depicted in FIGS. 16-18. The guide 175 also keeps a slider pull catch 177 aligned with the pull 166 of the pivoting latch 160 so the translation of the slider 170 over the distance D ensures that the slider pull catch 177 engages the pull 166 for rotating the pivoting latch 160 to a release position as depicted in FIGS. 16-18. Slider 170 also include a grip 178 disposed on an outer surface for the user to easily grab and translate the slider 170 along the longitudinal axis LA. FIGS. 25 and 26 are perspective views showing details of the inner body 180 of the retaining sub-assembly 160. The inner body 180 is used for retaining the pivoting latch 160 within the retaining sub-assembly 150 along with geometry that cooperates with the specific external fiber optic connector. Thus, it may be possible to swap-out the inner body and support other similar connectors with the retaining sub-assembly. Further, the retaining sub-assembly concepts disclosed could be used without the inner body by having the pivoting latch attach directly to the second component at the pivot location if desired.

Inner body 180 comprises an inner body passageway 182 disposed between an inner body rear end 181 and an inner body front end 183. The inner body 180 is sized for fitting into the second component passageway 82 of the second component 80. Specifically, the inner body 180 is configured for being inserted into the second component passageway 82 from the second component first end 81. The inner body 180 may include a plurality of retaining tabs 185 disposed near the inner component rear end 181 for attaching such as snap-fitting the inner body 180 within the second component passageway 82. The inner body 180 may also include a cutout 187 disposed at the inner body front end 183 of the inner body 180 that aligns with the window 80W of the second component 80 when assembled.

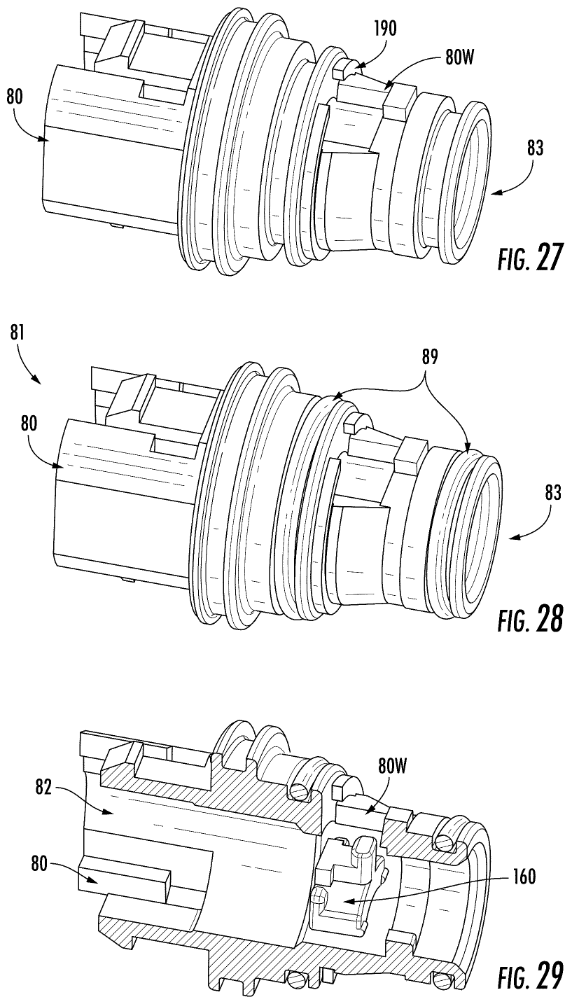

FIGS. 27-31 are perspective views showing the assembly of the retaining sub-assembly 160. FIG. 27 depicts installing the clip 190 in the clip seat 80CS of second component 80. FIG. 28 depicts the installation of one or more O-rings 89 on the second component 80. As shown, the O-rings 89 installed in FIG. 28 are the O-rings that cooperate with the slider 170 when installed for scaling between the slider 170 and the second component 80 at the respective ends of the slider and inhibiting dirt, debris and moisture from entering the fiber optic adapter 100. FIG. 29 shows the positioning of the pivoting latch 160 into the second component passageway 82 so it is aligned with the window 80W of the second component. FIG. 30 shows the positioning of the slider 170 about the second component second end 83. The slider 170 is aligned so that the guide 175 aligns with the pull 166 of the pivoting latch 160. FIG. 31 depicts the insertion of the inner body 180 into the second component passageway 82 from the second component first end 81 and aligned so that the cutout 187 of the inner body 180 aligns with the second component window 80W. The inner body 180 is used for retaining the pivoting latch 160 in retaining sub-assembly 160 and is inserted until the retaining tabs 185 are seated with the appropriate structure of the second component 80. FIGS. 32 and 33 are perspective views showing the assembled retaining sub-assembly 160 with the slider 170 removed for the sake of clarity to show further assembled details of the retaining sub-assembly 160.

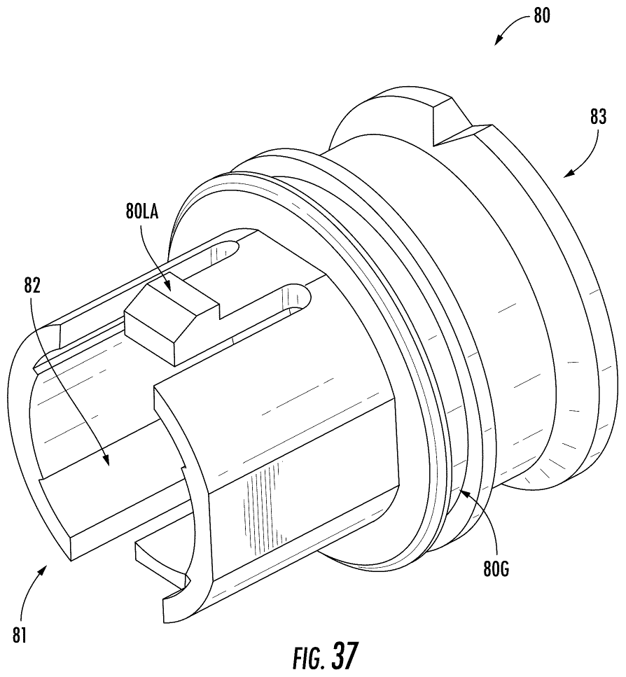

FIGS. 34 and 35 are perspective views of a second assembled fiber optic adapter 200 configured for receiving and optically mating an external fiber optic connector having a threaded coupling nut with an indoor connector according to the concepts disclosed. Fiber optic adapter 200 advantageously uses the first sub-assembly 99 shown in FIG. 13 having the fiber optic adapter core 50 and the first component 70 along with a different second component 80 shown in FIG. 37.

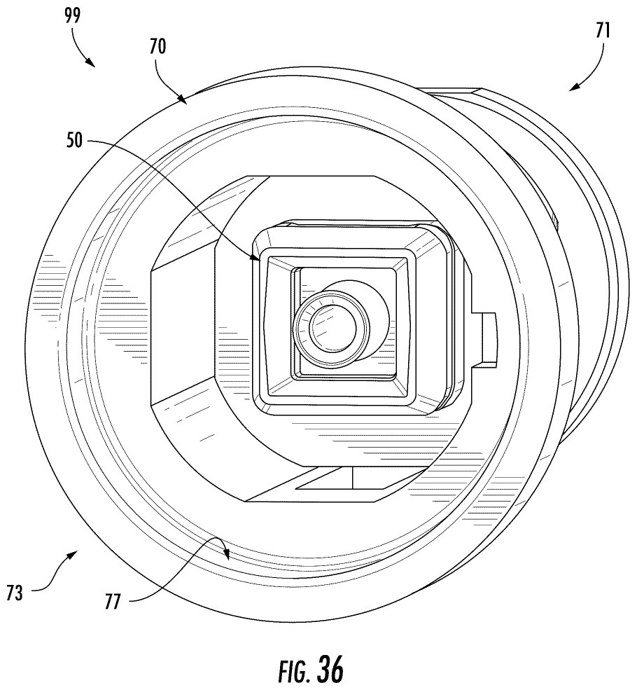

FIG. 36 shows a perspective view of the first sub-assembly 99 from the first component second end 73 with the adapter core (50) disposed in the first component 70 before the desired second component 80 is assembled to the first component 70 to form either fiber optic adapter 100, 200 as desired. As depicted, the fiber optic adapter core 50 is placed within the first component passageway 72 to form the first sub-assembly 99. The first sub-assembly may comprise one or more resilient members 40 as desired for biasing the fiber optic adapter core 50 within the adapter housing 60.

FIG. 37 shows a rear perspective view of the second component 80 used for fiber optic adapter 200 of FIGS. 34 and 35 configured for receiving and optically mating an external fiber optic connector having a threaded coupling nut. The second component 80 comprises second component passageway 82 extending from second component first end 81 to second component second end 83. Second component 80 comprises latch arms 80LA for securing the second component 80 to the first component 70. Specifically, latch arms 80LA snap-fit into respective first component windows 76 of the first component 70 for assembly. Further, the first component 70 may comprise an internal rim 77 configured for receiving and sealing between the first component 70 and the second component 80 using an O-ring 89 disposed within the groove 80G of the second component 80.

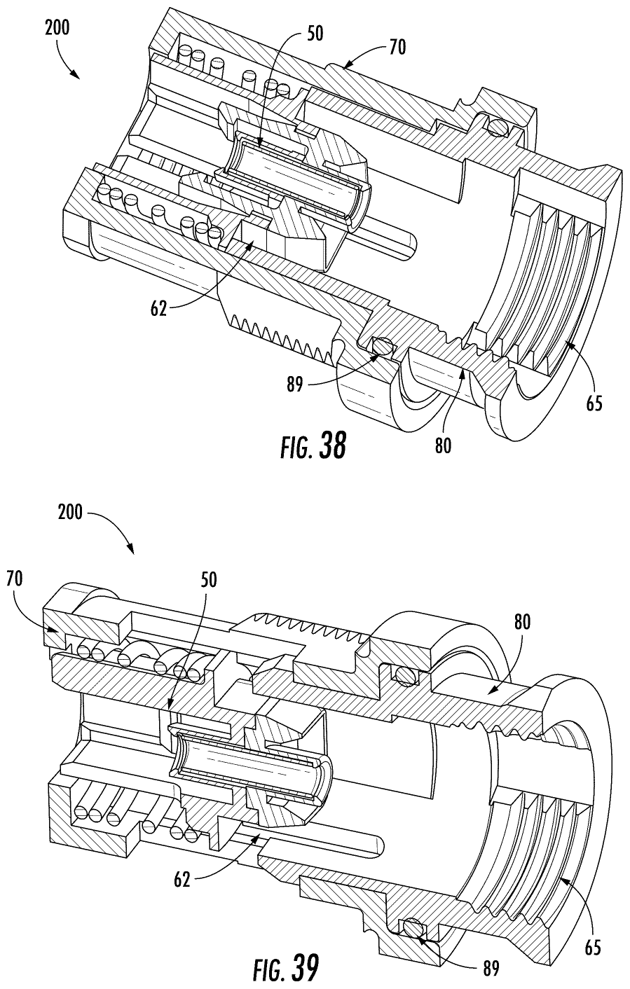

The first component 70 cooperates with the second component 80 and defines the adapter core cavity 62 for capturing the fiber optic adapter core 50 and one or more resilient members 40 when assembled. This second component 80 comprises a threaded portion 65 suitable for receiving and retaining a portion of an external fiber optic connector therein for optical mating within the fiber optic adapter. For instance, fiber optic adapter 200 is suitable for optical mating a SC connector with the OptiTap connector available from Corning Optical Communications of Charlotte, NC. FIGS. 38 and 39 are longitudinal sectional views taken along the connector insertion axis LA showing details of the fiber optic adapter 200 of FIGS. 34 and 35.

Although the disclosure has been illustrated and described herein with reference to explanatory embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

We claim:

1. A fiber optic adapter configured for receiving and optically mating an external fiber optic connector with an indoor connector, the fiber optic adapter comprising:
a rear core comprising a rear core body having a rear core passageway extending from a rear core rear end to a rear core front end and a flange disposed between the rear core rear end the rear core front end;
a front core comprising a front core body having a front core passageway extending from a front core rear end to a front core front end, wherein the assembly of the front core to the rear core defines a fiber optic adapter core when assembled;
one or more resilient members configured for engaging the flange of the rear core and biasing the fiber optic adapter core; and
an adapter housing comprising a first component and a second component, wherein the first component cooperates with the second component and defines an adapter core cavity for capturing the fiber optic adapter core and the one or more resilient members within the adapter core cavity when the fiber optic adapter is assembled, and the second component defines a second component passageway extending from a second component first end to a second component second end and the second component is configured for receiving a portion of the external fiber optic connector within the second component passageway for optical mating within the fiber optic adapter.

2. The fiber optic adapter of claim 1, wherein the rear core further comprises a keying feature that cooperates with a complimentary adapter keying feature disposed on the first component of the adapter housing.

3. The fiber optic adapter of claim 1, wherein the one or more resilient members is a single resilient member comprising a diameter configured for fitting about a rear end of the rear core.

4. The fiber optic adapter of claim 1, wherein the second component of the adapter housing comprises a portion of a retaining sub-assembly, and the retaining sub-assembly further comprises a pivoting latch configured for rotating transversely relative to a longitudinal axis of the fiber optic adapter for releasing the external fiber optic connector from the fiber optic adapter.

5. The fiber optic adapter of claim 4, wherein the retaining sub-assembly further comprises a slider capable of moving along the longitudinal axis of the fiber optic adapter for rotating the pivoting latch.

6. The fiber optic adapter of claim 4, wherein the sub-assembly further comprises an inner body sized for fitting into the second component passageway of the second component.

7. The fiber optic adapter of claim 4, wherein the sub-assembly further comprises a clip configured for being disposed on the second component and cooperating with the pivoting latch.

8. The fiber optic adapter of claim 1, further comprising a ferrule split sleeve configured for being captured between the rear core and the front core.

9. The fiber optic adapter of claim 1, further comprising one or more O-rings configured for being disposed on the second component.

10. The fiber optic adapter of claim 1, wherein the second component of the adapter housing comprises an interior threaded portion configured for securing the external fiber optic connector in the adapter for optical mating.

11. A fiber optic adapter configured for receiving and optically mating an external fiber optic connector with an indoor connector, the fiber optic adapter comprising:
a rear core comprising a rear core body having a rear core passageway extending from a rear core rear end to a rear core front end and a flange disposed between the rear core rear end the rear core front end;
a front core comprising a front core body having a front core passageway extending from a front core rear end to a front core front end, wherein the assembly of the front core to the rear core defines a fiber optic adapter core when assembled;
one or more resilient members configured for engaging the flange of the rear core and biasing the fiber optic adapter core; and
an adapter housing comprising a first component and a second component being a portion of a retaining sub-assembly, wherein the first component cooperates with the second component of the retaining sub-assembly and defines an adapter core cavity for capturing the fiber optic adapter core and the one or more resilient members within the adapter core cavity when the fiber optic adapter is assembled, and the second component defines a second component passageway extending from a second component first end to a second component second end and the second component is configured for receiving a portion of the external fiber optic connector within the second component passageway for optical mating within the fiber optic adapter.

12. The fiber optic adapter of claim 11, wherein the rear core further comprises a keying feature that cooperates with a complimentary adapter keying feature disposed on the first component of the adapter housing.

13. The fiber optic adapter of claim 11, wherein the one or more resilient members is a single resilient member comprising a diameter configured for fitting about a rear end of the rear core.

14. The fiber optic adapter of claim 11, the retaining sub-assembly further comprising a pivoting latch configured for rotating on a transversely relative to a longitudinal axis of the fiber optic adapter and configured for releasing the external fiber optic connector from the fiber optic adapter.

15. The fiber optic adapter of claim 12, wherein the retaining sub-assembly further comprises a slider capable of moving along the longitudinal axis of the fiber optic adapter for rotating the pivoting latch.

16. The fiber optic adapter of claim 11, wherein the sub-assembly further comprises an inner body sized for fitting into the second component passageway of the second component.

17. The fiber optic adapter of claim 11, wherein the sub-assembly further comprises a clip configured for being disposed on the second component.

18. The fiber optic adapter of claim 11, further comprising a ferrule split sleeve configured for being captured between the rear core and the front core.

19. The fiber optic adapter of claim 11, further comprising one or more O-rings configured for being disposed on the second component.

20. A fiber optic adapter configured for receiving and mating an external fiber optic connector with an indoor connector, the fiber optic adapter comprising:
a rear core comprising a rear core body having a rear core passageway extending from a rear core rear end to a rear core front end and a flange disposed between the rear core rear end the rear core front end;
a front core comprising a front core body having a front core passageway extending from a front core rear end to a front core front end, wherein the assembly of the front core to the rear core defines a fiber optic adapter core when assembled;
one or more resilient members configured for engaging the flange of the rear core and biasing the fiber optic adapter core; and
an adapter housing comprising a first component and a retaining sub-assembly comprising a second component and a pivoting latch, wherein the first component cooperates with the second component and defines an adapter core cavity for capturing the fiber optic adapter core and the one or more resilient members within the adapter core cavity when assembled, and the second component defines a second component passageway extending from a second component first end to a second component second end and the second component is configured for receiving a portion of the external fiber optic connector within the second component passageway with the pivoting latch configured for rotating transversely relative to a longitudinal axis of the fiber optic adapter for releasing the external fiber optic connector from the fiber optic adapter.

21. The fiber optic adapter of claim 20, wherein the rear core further comprises a keying feature that cooperates with a complimentary adapter keying feature disposed on the first component of the adapter housing.

22. The fiber optic adapter of claim 20, wherein the retaining sub-assembly further comprises a slider capable of moving along the longitudinal axis of the fiber optic adapter for rotating the pivoting latch.

23. The fiber optic adapter of claim 20, wherein the sub-assembly further comprises an inner body sized for fitting into the second component passageway of the second component.

24. The fiber optic adapter of claim 20, wherein the sub-assembly further comprises a clip configured for being disposed on the second component and cooperating with the pivoting latch.

25. The fiber optic adapter of claim 20, further comprising a ferrule split sleeve configured for being captured between the rear core and the front core.

26. The fiber optic adapter of claim 20, further comprising one or more O-rings configured for being disposed on the second component.

27. A fiber optic adapter core configured for use in a fiber optic adapter configured for receiving and mating an external fiber optic connector with an indoor connector, the fiber optic adapter core comprising:
a rear core comprising a rear core body having a rear core passageway extending from a rear core rear end to a rear core front end and a flange disposed between the rear core rear end and the rear core front end along with a plurality of openings disposed through a wall of the rear core, and wherein the rear core is configured for receiving the indoor connector into the rear core passageway; and
a front core comprising a front core body having a front core passageway extending from a front core rear end to a front core front end and a plurality of latch arms extending from the medial portion of the front core and sized for passing through respective openings of the rear core, wherein the plurality of latch arms are configured for securing the indoor connector within the rear core with the front core and the rear core defining the fiber optic adapter core when assembled.

28. The fiber optic adapter core of claim 27, further comprising a ferrule split sleeve.

29. The fiber optic adapter core of claim 27, further comprising a keying feature disposed on the rear core.

30. The fiber optic adapter core of claim 27 being a portion of a fiber optic adapter.
